(19) United States
(12) Patent Application Publication
(10) Pub. No.: US 2009/0043568 A1
(43) Pub. Date: Feb. 12, 2009

(54) Accent information extracting apparatus and method thereof

(75) Inventor: Takehiko Kagoshima, Kanagawa (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/071,390

(22) Filed: Feb. 20, 2008

(30) Foreign Application Priority Data
Aug. 9, 2007 (JP) 2007-207527

(51) Int. Cl. G10L 11/04

(52) U.S. Cl. 704/207; 704/E11.001

(57) ABSTRACT

An accent type is determined by outputting mora synchronized signals, extracting a pitch pattern which is a variation pattern of a voice height (fundamental frequency) from a speech signal entered by a user, generating mora synchronized pattern from the pitch pattern and the mora synchronized signal, storing typical patterns for respective accent types, collating the mora synchronized pattern and reference accent pattern, calculating matching of the mora synchronized patterns with respect to the respective accent types, referring the matching and determining the accent type.

### CROSS-REFERENCE TO RELATED APPLICATIONS

The application is based upon and claims the benefit of priority from the prior Japanese Patent Application NO. 2007-207527, filed on Aug. 9, 2007; the entire contents of which are incorporated herein by reference.

### BACKGROUND OF THE INVENTION

1. Field of the Invention

The present invention relates to an accent information extracting apparatus configured to extract accent information from speech signals vocalized by, for example, reading aloud a sentence and a method thereof.

2. Description of the Related Art

The text-to-speech synthesis is a technology to produce speech signals artificially from an entered given sentence (text). A text-to-speech synthesizer which realizes the text-to-speech synthesis is generally composed of a language processing unit, a rhythm processing unit and a speech synthesizing unit.

In this text-to-speech synthesizer, first of all, monophonemic analysis and syntax analysis of an entered text are carried out and information including reading (phonological matrix) and accent is generated in the language processing unit. Then, variation patterns (pitch patterns) of a tone of a voice are generated on the basis of the accent information in the rhythm processing unit. Finally, a speech waveform is generated according to the phonological matrix and the pitch patterns in the speech synthesizing unit.

When performing text-to-speech synthesis with respect to a Japanese sentence in which Kanji (Chinese) characters and kana (anonym) are mixed, there is a case in which the language processing unit reads the Kanji characters in a wrong way or in a wrong accent so that an expected speech cannot be obtained.

Therefore, as a method of generating a synthesized speech in correct reading and accent, a speech synthesizing system using a phonogram string as entry is known in the related art. The phonogram string means encoded information such as the phonological matrix or accent positions obtained as a result of the language analysis, and desired speech synthesis is achieved by preparing and entering the phonogram string with correct reading and accent.

As an example of a specification of the phonogram string, there is a standard of Japan Electronics and Information Technology Industries Association described in JEITA IT-4002 “Symbols for Japanese Text-to-Speech Synthesizer”). With this phonogram string, a correct reading is specified by entering a phonogram string of “sho'oji” or “tooka'irin” instead of a text in Kanji characters which has both ways of reading. In this specification, the phonogram string in alphabetical characters shown above represents pronunciation and the sign “'” represents the accent position. In the same manner, by entering the phonogram strings such as “tadashi'iyo'odesu” (it seems to be correct) and “ta'dashi_iyoode'su” (but it is strange) instead of a kana text, intended delimitations of the accented syllable and positions to be accented are specified. The under bar “_” represents here a delimitation of the accented syllable.

In order to write correct phonogram strings as described above, an exclusive knowledge about the speech and the language. Although the correct reading is relatively comprehensive, determination of the correct accented positions is difficult for general people who do not have the exclusive knowledge as described above.

Therefore, as a method of enabling general people to enter the accented positions, a method of determining the accent type automatically from a vocalized speech (see Japanese Publication Kokai No. 4-5697). In this method in the related art, speech data produced by a user is analyzed to extract entered pitch patterns, the extracted entered pitch patterns are collated with the reference pitch pattern to determine the similarity, whereby the accent type is determined.

The pitch patterns extracted from the speech vary in shape according to the speed of vocalization or the duration of respective vocalized phonological phrases, and hence the shapes of the pitch patterns are not necessarily the same even though the accent type is the same.

In contrast, the shapes might be similar even when the pitch patterns of the accent type are different.

However, the technology in the related art shown above has a problem that the accuracy of determination may be lowered due to the influence of the speed of vocalization or the duration of the phonological phrase as described above in order to determine the similarity of the pitch pattern extracted from the speech and the reference pattern.

### BRIEF SUMMARY OF THE INVENTION

Accordingly, it is an object of the invention to provide an accent information extracting apparatus with improved accuracy of extraction of accent types and a method thereof.

According to embodiments of the invention, there is provided an accent information extracting apparatus including a signal presenter configured to present mora synchronized signals as signals for indicating timings of vocalization on a mora-to-mora-basis to a user at given intervals; a speech input unit configured to receive a speech signal vocalized by the user synchronously with the mora synchronized signal; a pitch extracting unit configured to extract a pitch pattern from the speech signal; a mora generator configured to synchronize the mora synchronized signal and the pitch pattern and generate a mora synchronized pattern from the pitch pattern; an accent pattern storage configured to store reference accent patterns for respective accent types; and a determining unit configured to collate the respective reference accent patterns and the mora synchronized pattern and determine an accent type which is the most similar to the mora synchronized pattern.

The invention provides an accent information extracting apparatus including a signal presenter configured to output mora synchronized signals as signals for indicating timings of vocalization on a mora-to-mora-basis to a user at given intervals; a speech input unit configured to receive speech signals vocalized by the user synchronously with the mora synchronized signal; a pitch extracting unit configured to extract a pitch pattern from the speech signal, an accent pattern storage configured to store reference accent patterns for respective accent types; a text input unit configured to enter text data corresponding to the speech signal; a matrix generator configured to (1) generate at least one accent syllable information unit about the text data from the text data and the speech signal, the at least one accent syllable information unit being composed of a phrase having no accent or a phrase having one accent, and (2) combine the at least one accent syllable information unit and generate an accent syllable information matrix corresponding to the text data; a mora generator configured to synchronize the mora synchronized signal and the pitch pattern according to the number of moras in the at least one accent syllable information unit in the accent syllable information matrix and generate a mora synchronized pattern for each of the at least one accent syllable information unit from the pitch pattern; and a determining unit configured to collate the reference accent patterns and the mora synchronized pattern to determine a accent type most similar to the mora synchronized pattern for each or the at least one accent syllable information unit.

The invention provides an accent information extracting apparatus including a signal presenter configured to output mora synchronized signals as signals for indicating timings of vocalization on a mora-to-mora-basis to a user at given intervals; a speech input unit configured to receive a speech signal vocalized by the user synchronously with the mora synchronized signal; a pitch extracting unit configured to extract a pitch patterns from the speech signal; an accent pattern storage configured to store reference accent patterns for each accent type; a text input unit configured to enter text data corresponding to the speech signal; a candidate generator configured to (1) generate at least one accent syllable information unit about the text data from the text data and the speech signal, the at least one accent syllable information unit being composed of a phrase having no accent or a phrase having one accent, and (2) combine the at least one accent syllable information unit and generate at least one accent syllable information matrix candidate corresponding to the text data; a mora generator configured to (1) synchronize the mora synchronized signal and the pitch pattern according to the number of moras in the at least one accent syllable information unit of the at least one accent syllable information matrix candidate to generate a mora synchronized pattern for each of the at least one accent syllable information unit from the pitch pattern and (2) combine the generated at least one mora synchronized pattern matrix to generate a mora synchronized pattern matrix corresponding to each of the at least one accent syllable information matrix candidate; a collator configured to (1) collate each of the at least one mora synchronized pattern in the mora synchronized pattern matrix and the reference accent pattern to determine the similarity of the at least one mora synchronized pattern to the accent types respectively and (2) determine the similarity of the at least one mora synchronized pattern matrix from the similarity of the at least one mora synchronized pattern; and a selector configured to select the accent syllable information matrix candidate corresponding to the mora synchronized pattern matrix having the highest similarity from the similarities as a matched accent syllable information matrix which matches the speech signals.

According to the invention, the problems of the speed of vocalization and variations in duration of phonological phrase are alleviated by vocalizing synchronously with the mora synchronized signals and, simultaneously, accuracy of extraction of the accent types is improved by referring to the mora synchronized signals and extracting the pitch patterns synchronized with the moras and then collating the extracted pitch patterns with the reference accent patterns.

### BRIEF DESCRIPTION OF THE DRAWINGS

FIG. 1 is a block diagram of an accent information extracting apparatus according to a first embodiment of the invention; and

FIG. 2 is a block diagram of an interface unit;

FIG. 3A is a waveform diagram of a mora synchronized signal;

FIG. 3B is a speech waveform diagram;

FIG. 3C is a drawing showing a pitch pattern;

FIG. 3D is a drawing of a mora synchronized pattern;

FIG. 4 illustrates reference accent patterns;

FIG. 5 is an appearance drawing of the interface unit;

FIG. 6 is a block diagram of the accent information extracting unit according to a second embodiment of the invention;

FIG. 7 is a block diagram of the accent information extracting unit according to a third embodiment of the invention;

FIG. 8A shows word information matrix candidates;

FIG. 8B shows a matched word information matrix;

FIG. 9A shows accent syllable information matrix candidates;

FIG. 9B shows a matched accent syllable information matrix;

FIGS. 10A to 10C are drawing showing operation of the mora synchronized pattern generating unit; and

FIG. 11 is a waveform drawing of a mora synchronized signal whose envelope of amplitude varies periodically.

### DETAILED DESCRIPTION OF THE INVENTION

Referring now to the drawings, an accent information extracting apparatus according to respective embodiments of the invention will be described.

### First Embodiment

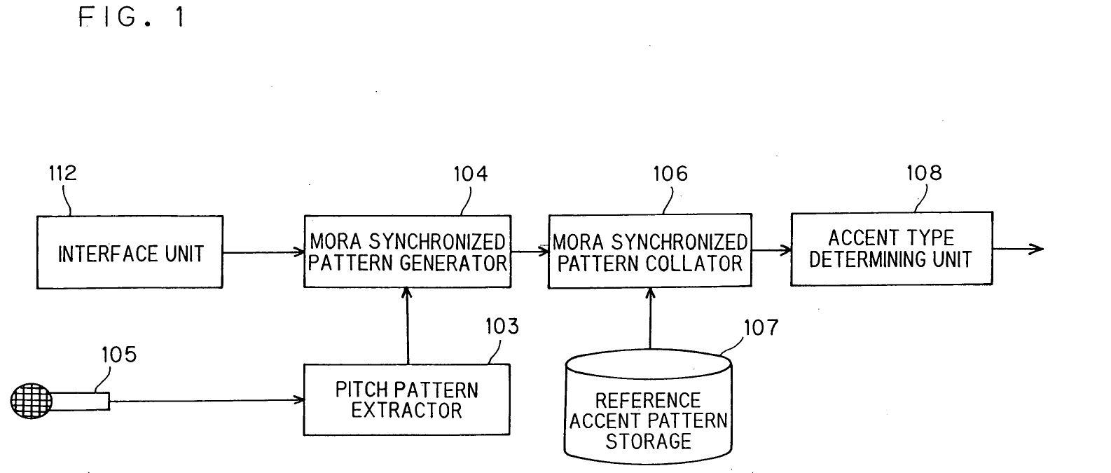

Referring now to FIG. 1 to FIG. 4, the accent information extracting apparatus according to the first embodiment of the invention will be described.

### (1) Configuration of Accent Information Extracting Apparatus

FIG. 1 is a block diagram of the accent information extracting apparatus according to the first embodiment.

The accent information extracting apparatus includes an interface unit 112 configured to output mora synchronized signals, a microphone 105 configured to enter a voice of a user, a pitch pattern extractor 103 configured to extract pitch patterns as a variation pattern of the voice height (fundamental frequency) from the entered speech, a mora synchronized pattern generator 104 configured to generate mora synchronized patterns from the pitch patterns and the mora synchronized signals, a reference accent pattern storage 107 configured to store typical patterns for the respective accent types, a mora synchronized pattern collator 106 configured to collate the mora synchronized pattern and the reference accent patterns to calculate the similarity of the mora synchronized pattern to the respective accent types, and an accent type determining unit 108 configured to refer to the similarity to determine the accent type.

The respective functions of the respective units 103, 104, 105, 106, 107, 108 and 112 are achieved by a program stored in a recording medium of a computer.

### (2) Operation of Accent Information Extracting Apparatus

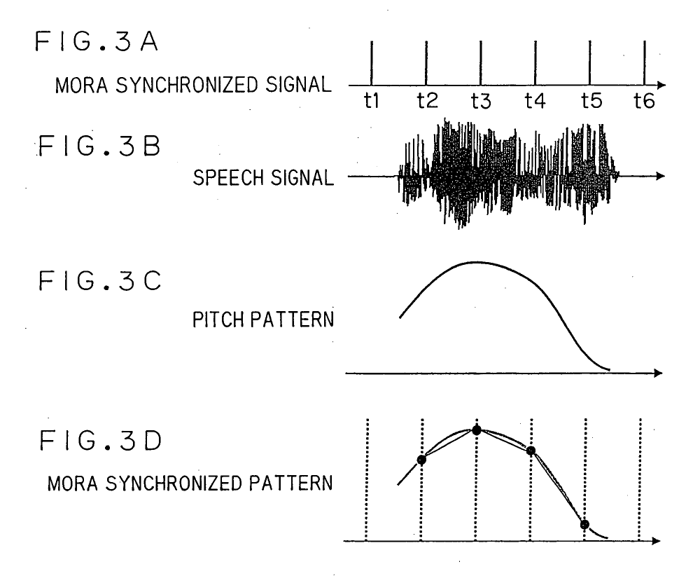

Referring now to FIGS. 3A to 3D, operation of the accent information extracting apparatus will be described.

Here, it is assumed that a third-accent word, “arayuru” is vocalized. The “third-accent” means that an accent nucleus is positioned at the third mora from the front. This speech is entered via the microphone 105. The speech waveform is shown in FIG. 3B.

Then, the pitch pattern extractor 103 extracts pitch patterns which is a matrix of the fundamental frequency (or logarithmic fundamental frequency) from the speech waveform. The pitch pattern is shown in FIG. 3C.

Then, the mora synchronized pattern generator 104 extracts values of the pitch patterns synchronously with the mora synchronized signal shown in FIG. 3A, that is, extracts values of the pitch patterns which correspond to the positions of the pulses (time instants) of the mora synchronized signals, and outputs the matrix of the values as the mora synchronized pattern (FIG. 3D).

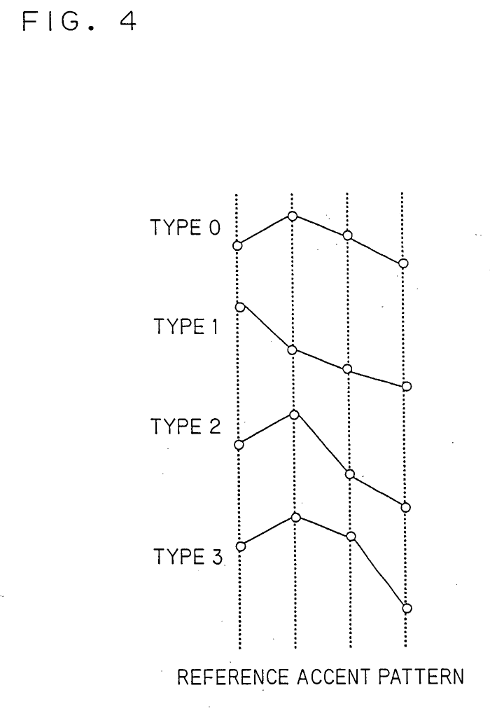

Then, the reference accent pattern storage 107 stores the reference accent patterns as a typical mora synchronized patterns as shown in FIG. 4 for the respective accent types. The reference accent patterns are prepared in advance, for example, by collecting a large number of mora synchronized patterns of vocalization whose accent patterns are already known, clustering these mora synchronized patterns by the accent types, and averaging the mora synchronized patterns in the respective clusters.

Then, the mora synchronized pattern collator 106 determines the distances between the reference accent patterns of the respective accent types in the reference accent pattern storage 107 and the mora synchronized patterns. Let xᵢ (i=1, 2, . . . N) denote the reference accent patterns of N moras and yi (i=1, 2, . . . N) themora synchronized patterns. The distance E is determined from the following expression. The distance E corresponds to the similarity.

$$E = {\sum }_{i = 1}^{N} {( {y}_{i} - {x}_{i} - c )}^{2}$$

$$c = {\sum }_{i = 1}^{N} ( {y}_{i} - {x}_{i} )$$

Then, the accent type determining unit 108 refers to the distance to the reference accent patterns of the respective accent types and determines the accent type which is at the nearest distance as the most similar accent type and outputs the same as the accent type of the entered speech.

### (3) Interface Unit 112

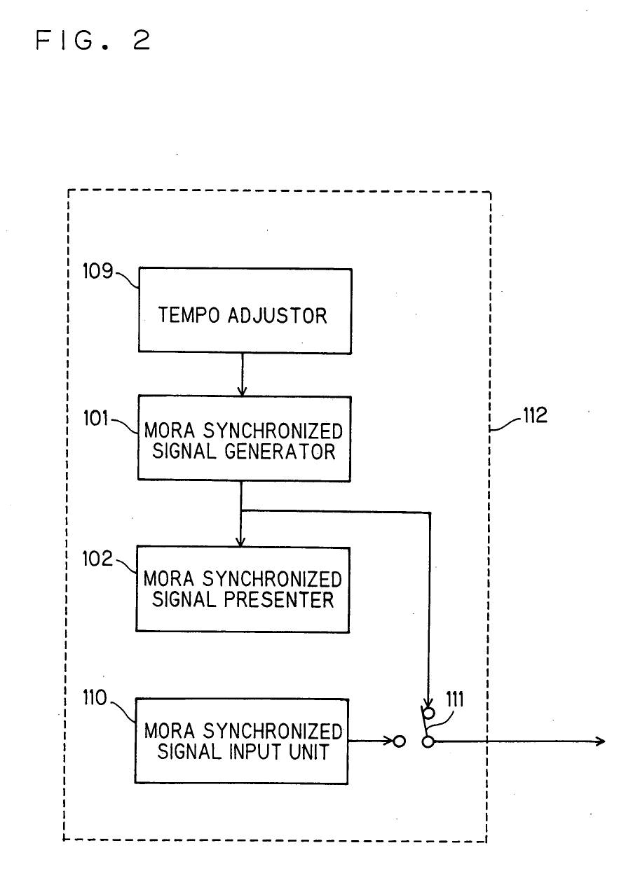

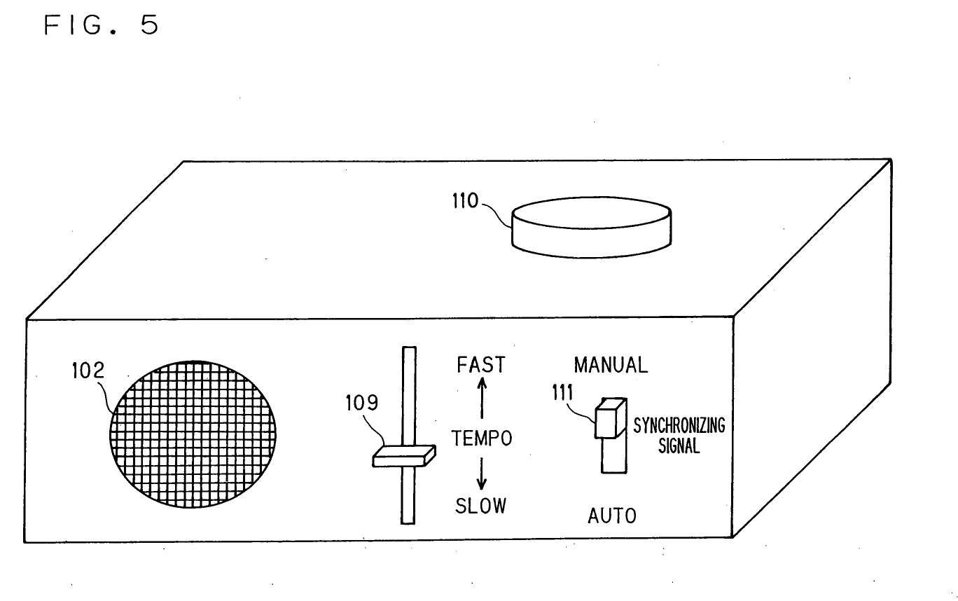

The interface unit 112 which outputs the mora synchronizing signals will be described below. FIG. 2 is a block diagram of the interface unit 112, and FIG. 5 shows the appearance thereof.

### (3-1) Configuration of Interface Unit 112

The interface unit 112 includes a mora synchronized signal generator 101, a tempo adjustor 109 configured to adjust the tempo of the mora synchronized signals, a mora synchronized signal presenter 102 configured to present the mora synchronized signals to the user, a switch 111 configured to switch the case between the case of generating the mora synchronized signals from the apparatus (that is, the case of the automatic operation) and the case of entering by the user (that is, the case of the manual operation), and a mora synchronized signal input unit 110.

### (3-2) Operation in Automatic Operation

First of all, operation in a case in which the switch 111 is connected to the mora synchronized signal generator 101 (to “Auto” side in FIG. 5) will be described.

The mora synchronized signal generator 101 generates a series of pulses at a constant frequency as shown in FIG. 3A as a mora synchronized signal. The user operates the tempo adjustor 109 when needed to enter tempo information to the mora synchronized signal generator 101, and changes the frequencies of the mora synchronized signals.

The mora synchronized signal presenter 102 is composed of a speaker, and presents the mora synchronized signals as a sound to the user.

The user produces a voice synchronously with the presented pulses of the constant frequency so that one pulse corresponds to one mora.

### (3-3) Operation in Manual Operation

Subsequently, operation in a case in which the switch 111 is connected to the mora synchronized signal input unit 110 (the “Manual” side in FIG. 5) will be described.

The user produces a voice while tapping the mora synchronized signal input unit 110 (the switch 110 in FIG. 5) at a constant tempo. The mora synchronized signals having pulses at the time instants when the mora synchronized signal input unit 110 is tapped are entered from the mora synchronized signal input unit 110, and the mora synchronized signals are outputted in the same manner as the case in which the mora synchronized signal generator 101 is used.

### (4) Advantage

In this manner, with the accent information extracting apparatus according to the first embodiment, the problem of fluctuations in speed of vocalization and in time length of the respective moras is solved by collating the pitch patterns of the speech vocalized synchronously with the mora synchronized signals with the reference pattern with reference to the mora synchronized signal, and accurate determination of the accent type is achieved.

### Second Embodiment

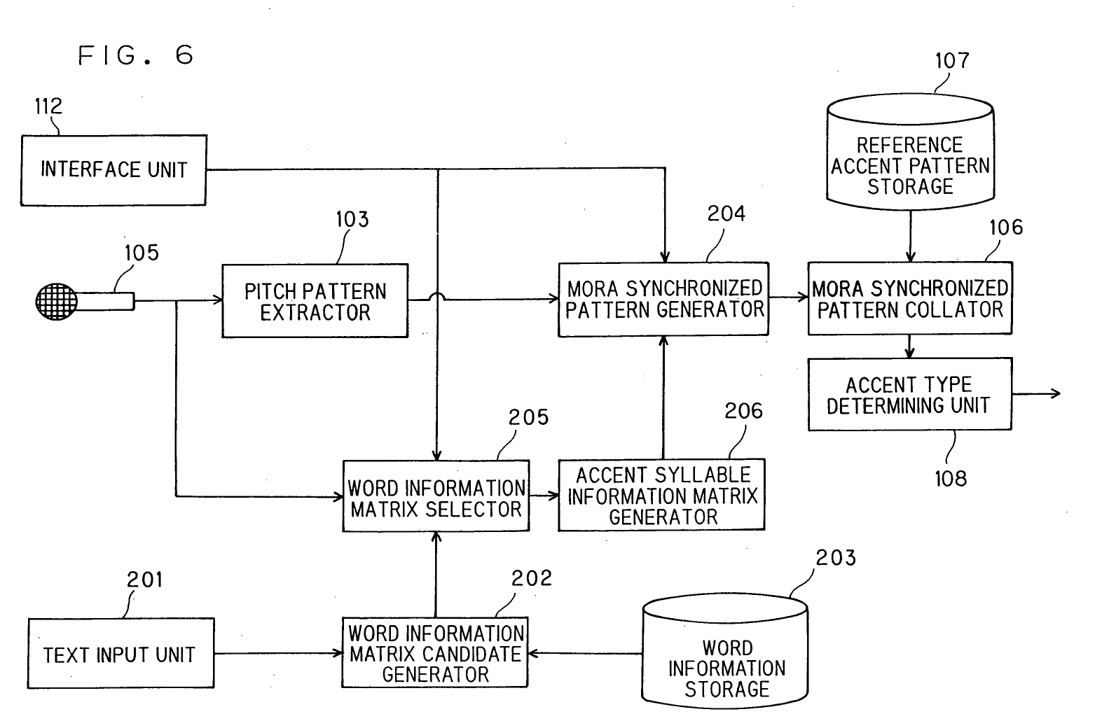

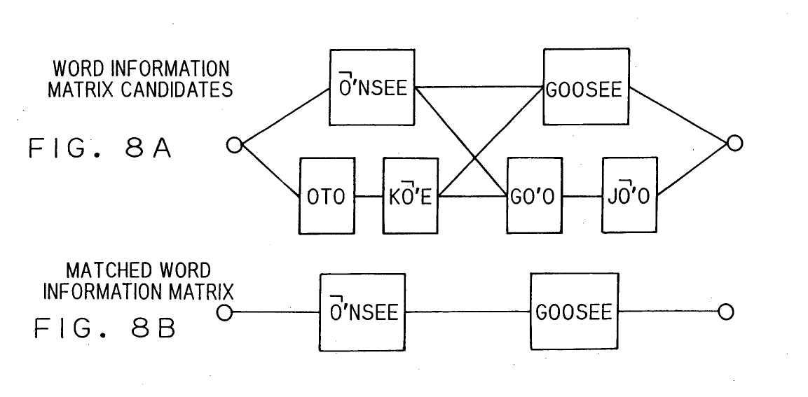

Referring now to FIG. 6 and FIGS. 8A and 8B, the accent information extracting apparatus according to the second embodiment will be described.

The accent information extracting apparatus according to the second embodiment is different from the accent information extracting apparatus in the first embodiment in that a text is entered in addition to the speech to extract the accent types of a plurality of the accent syllables included in one sentence.

### (1) Configuration of Accent Information Extracting Apparatus

FIG. 6 is a block diagram showing the accent information extracting apparatus according to the second embodiment.

The accent information extracting apparatus according to the second embodiment includes the interface unit 112 configured to output the mora synchronized signals, the microphone 105 configured to enter the voice of the user, the pitch pattern extractor 103 configured to extract the pitch patterns as the variation pattern of the voice height (fundamental frequency) form the entered speech, the reference accent pattern storage 107 configured to store a typical pattern for the respective accent types, and the mora synchronized pattern collator 106 configured to collate the mora synchronized patterns and the reference accent patterns to calculate the similarity of the mora synchronized patterns to the respective accent types, and the accent type determining unit 108 configured to refer to the similarity to determine the accent type.

According to the second embodiment, a text input unit 201, a word information storage 203, a word information matrix selector 205, an accent syllable information matrix generator 206, and a mora synchronized pattern generator 204 in which operation is different from the first embodiment are further provided.

### (2) Operation of Accent Information Extracting Apparatus

Operations of the respective units will be described in sequence below.

### (2-1) Text Input Unit 201

In the second embodiment, text data corresponding to the speech vocalized by the user is entered through the text input unit 201. The text input unit 201 may be a keyboard thorough which the user types the text data or may be configured to read a predetermined text file.

### (2-2) Word Information Matrix Candidate Generator 202

A word information matrix candidate generator 202 refers to word information stored in the word information storage 203 to generate word information matrix candidates from the text data.

The word information includes, for example, catch letters, word class, conjugation type, reading (pronunciation), accent type. For example, operation of the word information matrix candidate generator 202 in a case in which the text data includes a Japanese phrase which is pronounced as “onsee-goosee” (which means “speech synthesis”) will be described referring to FIG. 8.

The word information storage 203 includes registered word information having the catch letters of “oto” or “on”, “koe” or “see”, “goo”, “see” or “joo”, “onsee” and “goosee”. Using thee word information, the word information matrix candidates as shown in FIG. 8A are generated. FIGS. 8A and 8B shows that there are four possible candidates of “onsee-goosee”, “onsee-goo-joo”, “oto-koe-goosee”, and “oto-koe-goo-joo”.

In the case in which some word or phrase are connected before and after the Japanese text data “onseegoosee”, the word information matrix candidates are further increased and hence will be complicated. Therefore, only the portion of “onsee-goosee” will be described for simplifying description.

### (2-3) Word Information Matrix Selector 205

Then, the word information matrix selector 205 refers to the speech of the user entered through the microphone 105 and the mora synchronized signal, and selects a matched word information matrix which matches the vocalization of the user from the word information matrix candidates. As a technology to realize the word information matrix selector 205, various known speech recognition technologies may be employed.

An example in which the speech recognition technology is used will be described below.

First of all, a characteristic vector matrix which represents the characteristics of the spectrum of the entered speech is extracted from the input speech.

Then, acoustic models are prepared by modeling the spectrum of the phonological phrase with Hidden Malkov Model (HMM) in advance. On the basis of the acoustic models, an acoustic model matrix is prepared by connecting the acoustic models according to the pronunciation of the word information matrix.

Then, the likelihood is determined by collating the acoustic model matrix and the characteristic vector matrix of the entered speech. In this case, the word information matrix corresponding to the acoustic model matrix having a highest likelihood may be selected. Accuracy of selection is enhanced by aligning the acoustic model matrix with the characteristic vector matrix in the direction of time sequence so that 1 mora of the acoustic model corresponds exactly to 1 mora of the characteristic vector matrix with reference to the mora synchronized signal.

In this manner, “onsee-goosee” (FIG. 8B) having the highest likelihood is selected from the word information matrix candidates in FIG. 8A as a matched word information matrix.

When the number of moras of the vocalization is determined from the speech signals and the mora synchronized signals, the amount of calculation is reduced by collating only the word information matrix candidates having the same number of moras and selecting one from these candidates.

### (2-4) Accent Syllable Information Matrix Generator 206

Then, the accent syllable information matrix generator 206 generates an accent syllable information matrix from the selected matched word information matrix.

The accent syllable is a unit of vocalization which has one mora having an accent nucleus, and is normally composed of one or more consecutively connected words. However, in the case of the flat accent, there is no accent nucleus mora included therein.

Generation of the accent syllable information matrix as such is achieved by using regulations relating to the word class and the accent combining attribute included in the word information. For example, a regulation such as connecting an appended word to a proximate independent word is possible. When a sentence which means “Speech synthesis is to synthesize speeches” is given as the text data, the word information matrix is “onsee-goosee-wa-onsee-o-goosee-shi-masu”, and the accent syllable information matrix is “onseegooseewa-onseeo-gooseeshimasu”.

### (2-5) Mora Synchronized Pattern Generator 204

Then, the mora synchronized pattern generator 204 generates the mora synchronized patterns for the respective accent syllables from the mora synchronized signals and the accent syllable information matrix.

In other words, the mora synchronized patterns for the respective accent syllables are generated by extracting the values of the pitch patterns which correspond to the positions of the pulses of the mora synchronized signals according to the number of moras of the respective accent syllables in the accent syllable information matrix.

The generated mora synchronized patterns are collated with the reference accent patterns in sequence in the same manner as the first embodiment, so that the accent types of the respective accent syllables are determined.

### (3) Advantages

According to the second embodiment, the delimitations among the accent syllables and the accent types of the respective accent syllables are automatically determined even in the sentence having a plurality of accent syllables by analyzing the text data corresponding to the entered speech and collating the result of the analysis with the entered speech.

### Third Embodiment

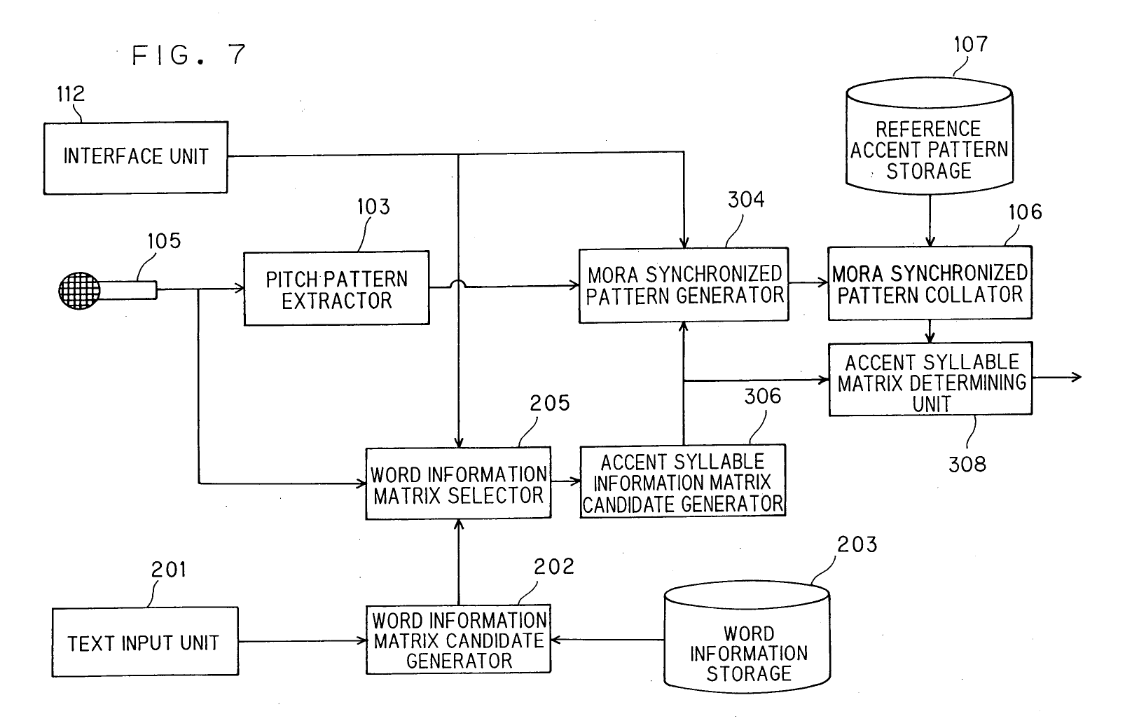

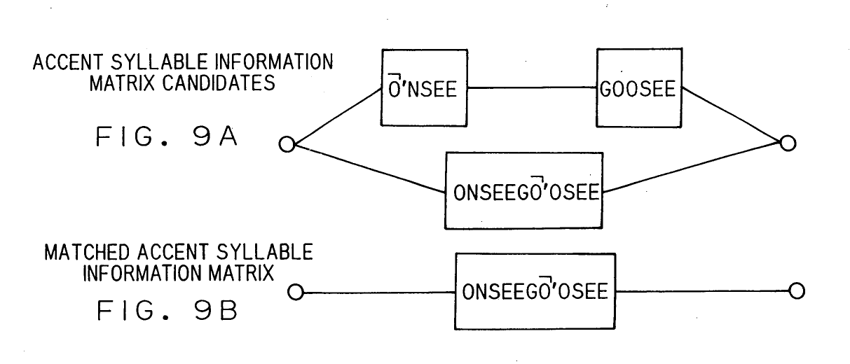

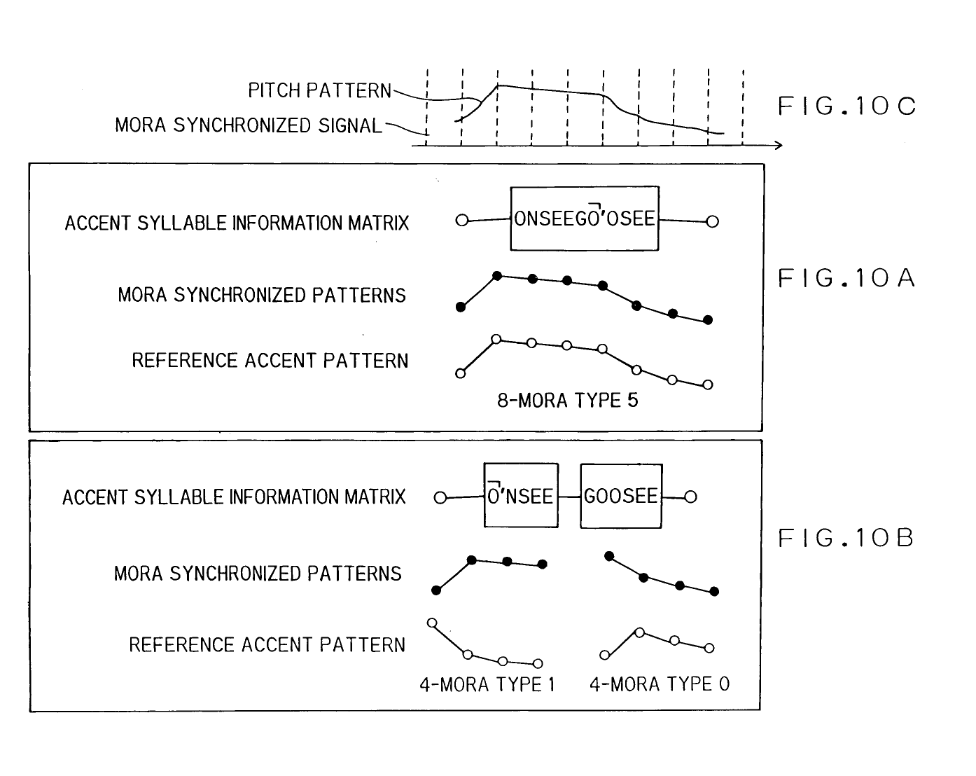

Referring now to FIG. 7, FIGS. 9A and 9B and FIGS. 10A to 10C, the accent information extracting apparatus according to a third embodiment will be described.

The third embodiment is different from the second embodiment in that the accent syllable information matrix is generated from the word information matrix by generating plurality of candidates and selecting a matched accent syllable information matrix on the basis of the result of collation with respect to the mora synchronized patterns instead of determining uniquely under the regulations.

### (1) Configuration of Accent Information Extracting Apparatus

FIG. 7 is a block diagram showing the accent information extracting apparatus according to the third embodiment.

In the third embodiment, the accent syllable information matrix generator 206 in the second embodiment is replaced by an accent syllable information matrix candidate generator 306 and the accent type determining unit 108 is replaced by an accent syllable matrix determining unit 308, respectively, and operation of a mora synchronized pattern generator 304 is different from the second embodiment.

### (2) Operation of Accent Information Extracting Apparatus

In the description given below, operation in the third embodiment will be described specifically on points of the third embodiment different from the second embodiment.

### (2-1) Accent Syllable Information Matrix Candidate Generator 306

The accent syllable information matrix candidate generator 306 generates accent syllable information matrix using regulation relating to the word class and the accent combining attribute included in the word information from the matched word information matrix.

In this case, a plurality of accent syllable information matrix candidates are generated instead of determining the accent syllable information matrix uniquely under the regulations when there is ambiguity. For example, in the case of the matched word information matrix “onsee-goosee” for the Japanese text data “onseegoosee”, “onsee-goosee” in which the word corresponds as is to the accent syllables and “onseegoosee” in which the accents are combined into an accent syllable are outputted as accent syllable information matrix candidates as shown in FIG. 9A.

### (2-2) Mora Synchronized Pattern Generator 304

Then, the mora synchronized pattern generator 304 generates a mora synchronized pattern matrixes on the basis of the pitch patterns extracted from the speech signals, the mora synchronized signals and the accent syllable information matrix candidates for the respective accent syllable information matrix candidates.

For example, when the pitch pattern and the mora synchronized signal shown in FIG. 10C are entered for the Japanese text data “onseegoosee”, the mora synchronized pattern shown in FIG. 10A is generated for the accent syllable information matrix candidate “onseegoosee”, and the mora synchronized pattern having two accent syllables as shown in FIG. 10B is generated for the accent syllable information matrix candidate “onsee-goosee”.

The generated mora synchronized patterns are collated with the reference accent patterns by the mora synchronized pattern collator 106, and the likelihoods for the respective accent patterns are outputted.

In the third embodiment, dispersion matrixes are stored in addition to the matrixes of the absolute value of the pitch as the reference accent patterns, and the likelihoods of the mora synchronized patterns with respect to the reference accent patterns are calculated.

### (2-3) Accent Syllable Matrix Determining Unit 308

The accent syllable matrix determining unit 308 synthesizes the likelihoods of the mora synchronized patterns included in the respective accent syllable information matrix candidates and calculates the likelihoods of the candidates, selects and outputs the candidates having the highest likelihood as the matched accent syllable information matrix.

Since the information of the accent types of the respective accent syllables is included in the accent syllable information matrix, the likelihood is calculated from the reference accent patterns and the mora synchronized patterns of the corresponding accent type.

In the example shown in FIG. 10A, the accent syllable information matrix “onseegoosee” is 8-mora type 5, and hence the likelihood of the reference accent pattern o type 5 and the mora synchronized pattern is calculated.

In the example shown in FIG. 10B, the accent syllable information matrix “onsee-goosee” is a two accent syllable including 4-mora type 1 and 4-mora type 0, and hence the likelihoods of the reference accent patterns and the mora synchronized patterns of type 1 and type 0 are calculated. When there are a plurality of accent syllables, the product of the likelihoods of the respective accent syllables may be determined as the likelihood of the corresponding matrix.

In the examples shown in FIG. 10A and FIG. 10B, since the likelihood in FIG. 10A is higher than the likelihood in FIG. 10B, “onseegoosee” having 8-mora type 5 accent is outputted as the matched accent syllable information matrix.

### (3) Advantages

According to the third embodiment, even when the delimitation of the accent syllable is ambiguous, further likely delimitation may be selected by collating with the entered speech. In addition, the language information may also be used by selecting one of the accent type candidates on the basis of the language information instead of determining the accent type only from the entered speech. Therefore, the third embodiment achieves an advantage that accuracy of the delimitations of the accent syllables and the accent type is improved.

### (Modifications)

The invention is not limited to the above-described embodiments, and various modifications may be made without departing the scope of the invention.

### (1) Modification 1

In the embodiments described above, the mora synchronized signal has been described as a pulse train. However, it maybe of any types of signals in which the amplitude, power and frequency are periodically varied as long as the user is able to sense the rhythm which is synchronized with the mora.

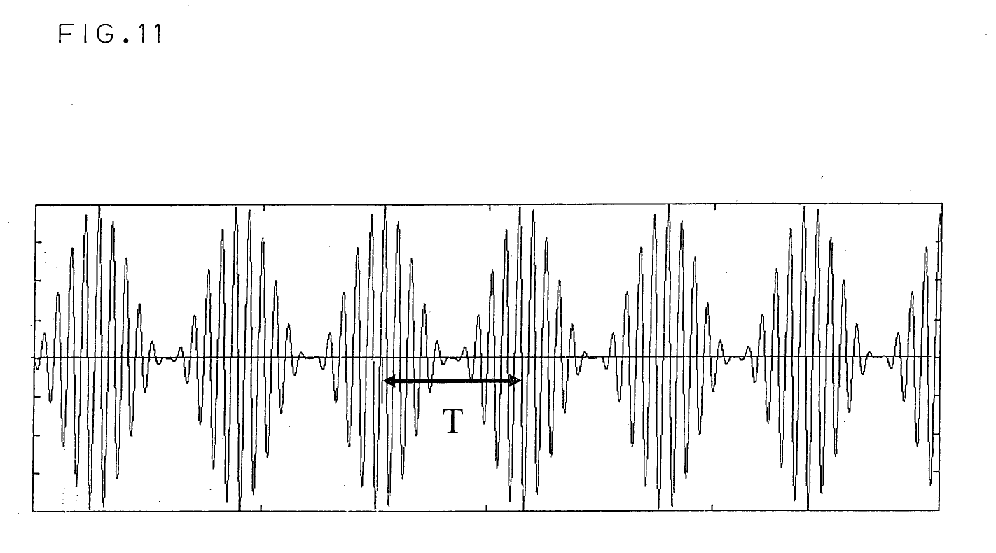

Referring now to FIG. 11, a case in which the power is applied will be described. By presenting signals whose envelope of the amplitude are periodically varied as the speech, variation in volume (power) with a period of time T is sensed, so that the signals may be used as the mora synchronized signals. Since the variations in power are extracted from the running mean of the square of the amplitude, the matrix of time instant which are synchronized with moras may be extracted by detecting the peak time instant thereof.

In the case of the frequency, for example, the vocalization may be synchronized with the timing when the sound is high.

The signal may be of any type as long as it is sensed to be substantially regular intervals by the user, and does not have to be completely periodic.

When the user enters through the mora synchronized signal input unit 110, the user may enter the mora synchronized signals which the user can easily vocalize, and the signal does not have to be periodic.

### (2) Modification 2

The mora synchronized signal presenter 102 has been described as a speaker thus far, it is not limited thereto, and may be various presenting means as long as the user is able to sense the rhythm.

It is also possible to present visually such as flashing light, change of color or deflection of needle, or with the sense of touch, for example, by causing the user to touch a vibrating movable portion.

### (3) Modification 3

The mora synchronized pattern generator 104 has been described as extracting the values of the pitch patterns which correspond to the positions of the pulses (time instants) of the mora synchronized signals and generating the mora synchronized patterns. However, since the speech might be advanced or delayed with respect to the mora synchronized signal, the values of the pitch patterns which correspond to the time instants shifted from the positions of pulses by a certain period may be extracted. For example, it is possible to use the time instants advanced from the pulse positions by 50 msec, or the time instants delayed by 30% in pulse intervals (cycles). With such compensation, improvement in accuracy is expected.

In the case of the mora synchronized signals in which the amplitude, power or frequency other than the pulse train are periodically varied, the mora synchronized patterns may be generated by extracting information on the positions of the pulses in terms of the time series by detecting the peak of variations and the zero cross.

### (4) Modification 4

The time series of the positions of pulses may be entered to the mora synchronized pattern generator 104 instead of entering the pulse train as the mora synchronized signals, and the same advantages as the embodiments described above may be obtained.

### (5) Modification 5

The mora synchronized patterns and the reference accent patterns have been described as having one pitch per mora. However, it is also possible to configure these patterns to have values of a plurality of points. In this case, the shape of the pattern is expressed further in detail, and hence the advantage such that accuracy of determination is improved is achieved.

### (6) Modification 6

The mora synchronized pattern collator 106 has been described as subtracting the average values of errors to determine the square error. However, the invention is not limited thereto, and various unit may be employed for measuring errors.

When the reference accent patterns specific for the speaker is prepared, the square error may be calculated without subtracting the average value of errors. It is also possible to provide the sample statistic such as dispersion in addition to the absolute value of the pitches as the reference accent patterns to calculate the likelihoods of the mora synchronized patterns.

A plurality of the reference accent patterns may be provided for one accent type. When the plurality of reference accent patterns are stored for the respective accent types, it may be used properly depending on the number of moras or the absence or presence of poses before and after.

What is claimed is:

1. An accent information extracting apparatus comprising:
a signal presenter configured to present mora synchronized signals as signals for indicating timings of vocalization on a mora-to-mora-basis to a user at given intervals;
a speech input unit configured to receive a speech signal vocalized by the user synchronously with the mora synchronized signal;
a pitch extracting unit configured to extract a pitch pattern from the speech signal;
a mora generator configured to synchronize the mora synchronized signal and the pitch pattern and generate a mora synchronized pattern from the pitch pattern;
an accent pattern storage configured to store reference accent patterns for respective accent types; and
a determining unit configured to collate the respective reference accent patterns and the mora synchronized pattern and determine an accent type which is the most similar to the mora synchronized pattern.

2. An accent information extracting apparatus comprising:
a signal presenter configured to present mora synchronized signals as signals for indicating timings of vocalization on a mora-to-mora-basis to a user at given intervals;
a speech input unit configured to receive speech signals vocalized by the user synchronously with the mora synchronized signal;
a pitch extracting unit configured to extract a pitch pattern from the speech signal,
an accent pattern storage configured to store reference accent patterns for respective accent types;
a text input unit configured to enter text data corresponding to the speech signal;
a matrix generator configured to (1) generate at least one accent syllable information unit about the text data from the text data and the speech signal, the at least one accent syllable information unit being composed of a phrase having no accent or a phrase having one accent, and (2) combine the at least one accent syllable information unit and generate an accent syllable information matrix corresponding to the text data;
a mora generator configured to synchronize the mora synchronized signal and the pitch pattern according to the number of moras in the at least one accent syllable information unit in the accent syllable information matrix to generate a mora synchronized pattern for each of the at least one accent syllable information unit from the pitch pattern; and
a determining unit configured to collate the reference accent patterns and the mora synchronized pattern to determine a accent type most similar to the mora synchronized pattern for each or the at least one accent syllable information unit.

3. An accent information extracting apparatus comprising:
a signal presenter configured to present mora synchronized signals as signals for indicating timings of vocalization on a mora-to-mora-basis to a user at given intervals;
a speech input unit configured to receive a speech signal vocalized by the user synchronously with the mora synchronized signal;
a pitch extracting unit configured to extract a pitch patterns from the speech signal;
an accent pattern storage configured to store reference accent patterns for each accent type;
a text input unit configured to enter text data corresponding to the speech signal;
a candidate generator configured to (1) generate at least one accent syllable information unit about the text data from the text data and the speech signal, the at least one accent syllable information unit being composed of a phrase having no accent or a phrase having one accent, and (2) combine the at least one accent syllable information unit and generate at least one accent syllable information matrix candidate corresponding to the text data;
a mora generator configured to (1) synchronize the mora synchronized signal and the pitch pattern according to the number of moras in the at least one accent syllable information unit of the at least one accent syllable information matrix candidate to generate a mora synchronized pattern for each of the at least one accent syllable information unit from the pitch pattern and (2) combine the generated at least one mora synchronized pattern matrix to generate a mora synchronized pattern matrix corresponding to each of the at least one accent syllable information matrix candidate;
a collator configured to (1) collate each of the at least one mora synchronized pattern in the mora synchronized pattern matrix and the reference accent pattern to determine the similarity of the at least one mora synchronized pattern to the accent types respectively and (2) determine the similarity of the at least one mora synchronized pattern matrix from the similarity of the at least one mora synchronized pattern; and
a selector configured to select the accent syllable information matrix candidate corresponding to the mora synchronized pattern matrix having the highest similarity from the similarities as a matched accent syllable information matrix which matches the speech signals.

4. The apparatus according to claim 2, wherein the matrix generating unit comprises:
a word storage configured to store word information units including at least a phonological phrase for respective words;
a word generator configured to generate at least one word information matrix candidate composed of word information on the at least one word included in the text data on the basis of the stored word information of the at least one word included in the text data;
a speech spectrum extractor configured to extract the speech spectrum from the speech signals;
a phonological phrase spectrum storage configured to store phonological phrase spectra for respective phonological phrases;
a phonological phrase spectrum extractor configured to extract phonological phrase spectra for the respective phonological phrases of the word included in the word information matrix candidates from the phonological phrase spectrum storage;
a word selector configured to compare the phonological phrase spectra for the respective phonological phrases included in the word information matrix candidates and the speech spectrum and select the word information matrix candidate which is the most similar to the speech spectrum as a matched word information matrix; and
a second matrix generator configured to (1) combine the phonological phrase of the at least one word in the matched word information matrix to generate the accent syllable information and (2) combine the at least one accent syllable information to generate an accent syllable information matrix corresponding to the matched word information matrix.

5. The apparatus according to claim 3, wherein the candidate generating unit comprises:
a word storage configured to store word information units including at least a phonological phrase for respective words;
a word generator configured to generate at least one word information matrix candidate composed of word information on the at least one word included in the text data on the basis of the stored word information of the at least one word included in the text data;
a speech spectrum extractor configured to extract the speech spectrum from the speech signals;
a phonological phrase spectrum storage configured to store phonological phrase spectra for respective phonological phrases;
a phonological phrase spectrum extractor configured to extract phonological phrase spectra for the respective phonological phrases of the word included in the word information matrix candidates from the phonological phrase spectrum storage;
a word selector configured to compare the phonological phrase spectra for the respective phonological phrases included in the word information matrix candidates and the speech spectrum and select the word information matrix candidate which is the most similar to the speech spectrum as a matched word information matrix; and
a second matrix generator configured to (1) combine the phonological phrase of the at least one word in the matched word information matrix to generate the accent syllable information and (2) combine the at least one accent syllable information to generate at least one accent syllable information matrix candidate corresponding to the matched word information matrix.

6. The apparatus according to claim 1, wherein the signal presenter comprises:
a presenting unit configured to present the mora synchronized signal to the user; and
an adjuster configured to adjust the intervals of the mora synchronized signals by the user.

7. The apparatus according to claim 1, wherein the signal presenter presents the mora synchronized signals by being operated by the user.

8. The apparatus according to claim 1, wherein the signal presenter presents a signal in which at least any one of amplitude, power and frequency is varied periodically as the mora synchronized signals.

9. The apparatus according to claim 2, wherein the signal presenter comprises:
a presenting unit configured to present the mora synchronized signal to the user; and
an adjuster configured to adjust the intervals of the mora synchronized signals by the user.

10. The apparatus according to claim 2, wherein the signal presenter presents the mora synchronized signals by being operated by the user.

11. The apparatus according to claim 2, wherein the signal presenter presents a signal in which at least any one of amplitude, power and frequency is varied periodically as the mora synchronized signals.

12. The apparatus according to claim 3, wherein the signal presenter comprises:
a presenting unit configured to present the mora synchronized signal to the user; and
an adjuster configured to adjust the intervals of the mora synchronized signals by the user.

13. The apparatus according to claim 3, wherein the signal presenter presents the mora synchronized signals by being operated by the user.

14. The apparatus according to claim 3, wherein the signal presenter presents a signal in which at least any one of amplitude, power and frequency is varied periodically as the mora synchronized signals.

15. An accent information extracting method comprising:
presenting mora synchronized signals as signals for indicating timings of vocalization on a mora-to-mora-basis to a user at given intervals;
receiving a speech signal vocalized by the user synchronously with the mora synchronized signal;
extracting the pitch pattern from the speech signal;
synchronizing the mora synchronized signal and the pitch pattern and generating mora synchronized pattern from the pitch pattern;
storing reference accent patterns for respective accent types; and
colleting the respective reference accent patterns and the mora synchronized pattern and determining an accent type which is the most similar to the mora synchronized pattern.

16. An accent information extracting program stored in a computer readable medium, the program comprises instructions of:
presenting mora synchronized signals as signals for indicating timings of vocalization on a mora-to-mora-basis to a user at given intervals;
receiving a speech signal vocalized by the user synchronously with the mora synchronized signal;
extracting a pitch pattern from the speech signal;
synchronizing the mora synchronized signal and the pitch pattern and generating a mora synchronized pattern from the pitch pattern;
storing reference accent patterns for respective accent types; and
collating the respective reference accent patterns and the mora synchronized pattern and determining an accent type which is the most similar to the mora synchronized pattern.
